(19) United States
(12) Patent Application Publication
(10) Pub. No.: US 2012/0167056 A1
(43) Pub. Date: Jun. 28, 2012

(54) DEBUGGER FOR A METADATA-CENTRIC DEVELOPMENT INFRASTRUCTURE

(75) Inventors: Frank Brunswig, Heidelberg (DE); Frank Jentsch, Muehlhausen (DE); Baré Said, Sankt Leon-Rot (DE)

(73) Assignee: SAP AG, Walldorf (DE)

(21) Appl. No.: 12/977,312

(22) Filed: Dec. 23, 2010

(51) Int. Cl. G06F 9/44

(52) U.S. Cl. 717/129; 717/127

(57) ABSTRACT

A computer system includes a metadata repository that is arranged and configured to store multiple meta-objects, at least one execution engine that is operably coupled to the metadata repository and that is arranged and configured to process one or more of the meta-objects during a runtime process and a debug manager that is operably coupled to the metadata repository and to the at least one execution engine and that is arranged and configured to provide an interface to the at least one execution engine and to manage one or more debug processes at a metadata level.

### TECHNICAL FIELD

This description relates to a debugger for a metadata-centric development infrastructure.

### BACKGROUND

Many businesses and organizations may utilize services (e.g., software applications) that may be provided by one or more providers that may offer user interfaces (UI)s for accessing applications that may be customized for a particular user. Providers may find it desirable to provide systems and techniques that make it easier for developers and other users to create and use these services and UIs.

Debugging is part of the process used by developers when creating these services and UIs. In some implementations, the development process is on a metadata-based level; however, the debugging process is not at the metadata level and instead is based on runtime artifacts and generated source code. That means the development process and the debugging process are on different abstraction levels. Having the development process and the debugging process on different abstraction levels may force the developer to perform a continuous logical model transformation from design time to runtime model. This may result in reduced capability to detect and correct errors in applications, programs, services, and UIs by the developer. It may be desirable to provide systems and techniques to improve the debugging process.

### SUMMARY

According to one general aspect, a computer system includes a metadata repository that is arranged and configured to store multiple meta-objects, at least one execution engine that is operably coupled to the metadata repository and that is arranged and configured to process one or more of the meta-objects during a runtime process and a debug manager that is operably coupled to the metadata repository and to the at least one execution engine and that is arranged and configured to provide an interface to the at least one execution engine and to manage one or more debug processes at a metadata level.

Implementations may include one or more of the following features. For example, one or more of the meta-object models may include an object model and a debug model, where the debug model comprises debug information and the debug manager is arranged and configured to obtain and use the debug information the manage one or more of the debug processes at the metadata level. The debug information may include breakpoint information and watchpoint information for a specific object model.

The system may further include at least one debugger client process that is arranged and configured to run as a user interface application and a debugger service that is arranged and configured to interface between the at least one debugger client process and the debug manager, where the debug manager is arranged and configured to notify the at least one debugger client process of debug information. The at least one debugger client process may include a breakpoint view and a datawatch view. The at least one debugger client process may be arranged and configured to enable and disable breakpoints and watchpoints.

The computer system may further include at least one user interface application, wherein the debug manager is arranged and configured to interface with the user interface application to initiate at least one debugger client process.

In another general aspect, a method includes executing instructions recorded on a non-transitory computer-readable storage media using at least one processor. The method includes storing multiple meta-objects, processing one or more of the meta-objects during a runtime process and managing one or more debug processes at a metadata level.

Implementations may include one or more of the following features. For example, one or more of the meta-object models may include an object model and a debug model, where the debug model may include debug information, and the method may further include obtaining and using the debug information the manage one or more of the debug processes at the metadata level. The debug information may include breakpoint information and watchpoint information for a specific object model.

The method may further include running at least one debugger client process as a user interface application, interfacing with the at least one debugger client process and notifying the at least one debugger client process of debug information. The at least one debugger client process may include a breakpoint view and a datawatch view. The method may further include using the at least one debugger client process to enable and disable breakpoints and watchpoints. The method may further include interfacing with at least one user interface application to initiate at least one debugger client process.

In another general aspect, a recordable storage medium has recorded and stored thereon instructions that, when executed, cause at least one processor to perform the actions of storing multiple meta-objects, processing one or more of the meta-objects during a runtime process and managing one or more debug processes at a metadata level.

Implementations may include one or more of the following features. For example, one or more of the meta-object models may include an object model and a debug model, where the debug model comprises debug information, and may further include instructions that, when executed, cause the at least one processor to perform the actions of obtaining and using the debug information the manage one or more of the debug processes at the metadata level. The debug information may include breakpoint information and watchpoint information for a specific object model.

The recordable storage medium may further include instructions that, when executed, cause the at least one processor to perform the actions of running at least one debugger client process as a user interface application, interfacing with the at least one debugger client process and notifying the at least one debugger client process of debug information. The at least one debugger client process may include a breakpoint view and a datawatch view.

The recordable storage medium may further include instructions that, when executed, cause the at least one processor to perform the action of using the at least one debugger client process to enable and disable breakpoints and watchpoints.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for a development infrastructure.

FIG. 2 is a flowchart illustrating example operations of the system of FIG. 1.

FIG. 3 is an exemplary timing diagram illustrating example operations of the system of FIG. 1.

FIG. 4 is an exemplary timing diagram illustrating example operations of the system of FIG. 1.

FIG. 5 is an exemplary timing diagram illustrating example operations of the system of FIG. 1.

### DETAILED DESCRIPTION

This document describes systems and techniques for a metadata-centric development infrastructure including a debugging infrastructure. Debugging is a process that includes detecting, locating and correcting logical or syntactical errors in a program or malfunctions in hardware. A developer uses a debugging process, for example, to detect, locate and correct errors when developing an application. A developer may use a debugger, which is a program designed to aid in debugging another program by allowing the programmer to step through the program, examine the data, and monitor conditions such as the values of variables. The debugging infrastructure described in this document enables a developer to perform these debugging functions at a metadata level.

Debugging tools allow a developer to monitor program execution, check, interrupt and exception handling, inspect data values, and perform other tasks that allow software operation to be checked and verified. The debugging process typically includes halting program execution by setting breakpoints at selected points or by setting watch points that may trigger breakpoints when specified memory addresses are accessed or reach certain values or when subroutines or other sections of code are executed. The debugging infrastructure described in this document enables the developer to set these breakpoints and watch points at a metadata level as opposed to a source code level. This enables the developer to debug the program at the same abstraction level that the design time application was used to develop the application.

The debugging infrastructure is included as part of the metadata-centric development infrastructure. The metadata-centric development infrastructure includes design time user interface applications that enable users, such as developers, to design, create and edit programs, applications, UIs and services. In one example, the design time application may be used to create and edit application-specific models. Metadata-centric means that for specific domains, for example, the user interface or business objects in the application-specific models are described by metadata. The metadata used to describe these objects is stored in a metadata repository which is available both at design time and at runtime.

The debugging infrastructure, which is part of the development infrastructure, includes a debug manager that is coupled to the metadata repository and to the execution engines, which execute requested metadata stored from the metadata repository. The debug manager provides an interface to the execution engines and manages one or more debug processes at a metadata level. In this manner, developers may debug applications at the same abstraction level as the development process, that is, on the metadata level. The developer can debug applications on the business and semantic level. The debugging infrastructure enables a developer to set breakpoints and watch points, which may be related to a domain specific script. The developer does not have to perform a continuous logical model transformation from design time to runtime during the debugging process.

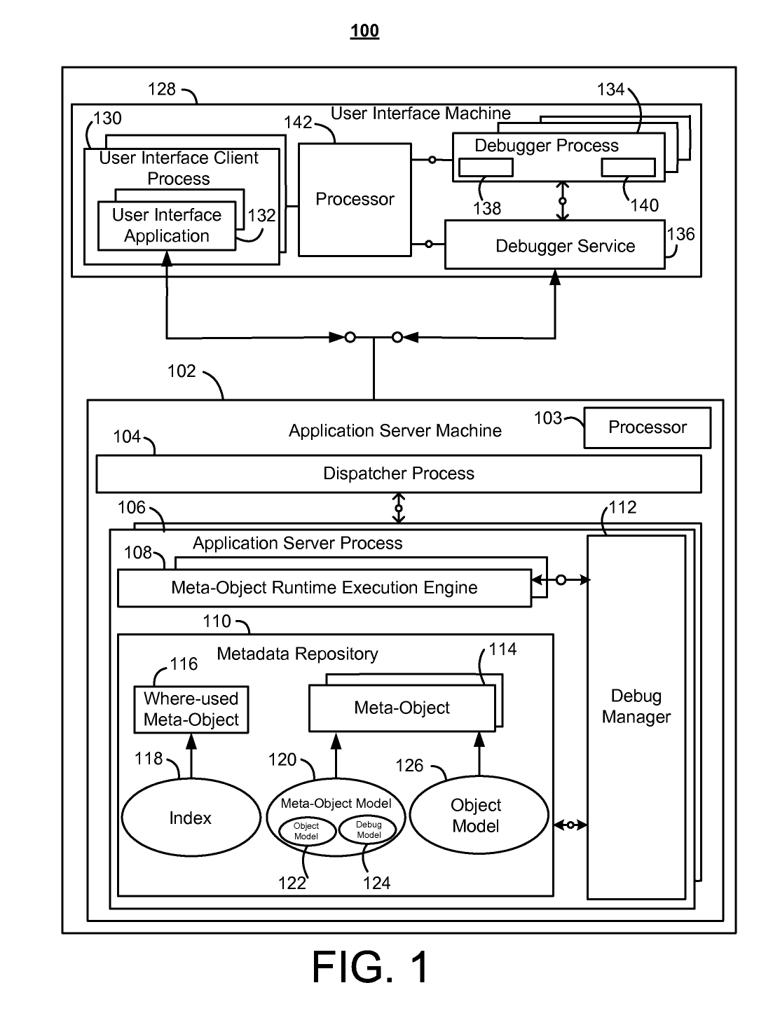

Referring to FIG. 1, an exemplary block diagram illustrates a system 100 for a metadata-centric software development infrastructure, which includes a debugger infrastructure. The system 100 includes components on an application server machine 102 as well as on a user interface machine 128. The system 100 enables a developer to instantiate a debugger interface and to perform debugging processes at a metadata level. The system 100 enables the developer to set breakpoints and watch points in order to debug applications and components of applications.

The application server machine 102 includes a processor 103, a dispatcher process 104, and one or more application server processes 106. The application server machine 102 may be a computing device that is configured to execute instructions which may be stored on the server machine 102. The application server machine 102 may include at least one processor 103 which may be configured to execute the instructions and perform the processes implemented by the server 102. The processor 103 may be operably coupled to and interface with all of the other components on the application server 102. The application server machine 102 may include other components (not shown) typically found on computing devices such as, for example, memory (e.g., random access memory, read-only memory, flash memory, and other types of memory), other processors and controllers, input/output controllers, and other components to enable the application server machine 102 to function as a computing device.

The dispatcher process 104 may be an interface between the application server machine 102 and the user interface machine 128. The dispatcher process 104 may transmit and receive messages, data and other communications over a network between the application server machine 102 and other computing devices such as, for example, the user interface machine 128. The network (not shown) connects the application server machine 102, via the dispatcher process 104, to other computing devices including the user interface machine 128. Examples of the communication network include a local area network (LAN) and a wide area network (WAN) such as, for example, the Internet. The network may be a wired and/or a wireless network.

The dispatcher process 104 also may be configured to instantiate multiple application server processes 106. The dispatcher process 104 also may be configured to coordinate the communication of messages from the user interface machine 128 and to appropriately route messages and communications to the designated application server process 106. The dispatcher process 104 may be the central controller of each instance of an application server process 106.

The application server process 106 may include one or more meta-object runtime execution engines 108, a metadata repository 110 and a debug manager 112. The application server process 106 includes instructions that are stored on a memory and executed by the processor 103 to perform the functions for the components that are part of the application server process 106. The application server process 106 includes components that can execute or run one or more applications or programs, where each instantiation of an application server process 106 may be linked to a memory area containing the context of the application being run.

The meta-object runtime execution engines 108 may include one or more execution engines which perform processes on the meta-objects 114, which are stored in the metadata repository 110. For each type of meta-object, there may be a specific execution engine to process that type of meta-object. For example, the execution engines 108 may include a user interface execution engine, a business object execution engine, an inbound agent execution engine, an analytic view execution engine, and a fast search execution engine. These various types of execution engines are arranged and configured to process one or more of the meta-objects during a runtime process.

The execution engines 108 may respond to requests for objects and instances of meta-objects by the user interface machine 128. The meta-object execution engines 108 are operably coupled to the metadata repository 110 and to the debug manager 112. The execution engines 108 may be domain-specific metadata runtime execution engines, for example, the user interface controller framework or the business-object infrastructure at runtime.

The metadata repository 110 may be configured to store meta-objects 114 and where-used meta-objects 116. The metadata repository 110 may be implemented as a database on a memory to store the meta-objects 114 and where-used meta-objects 116. The metadata stored in the metadata repository 110 may be available at both design time and at runtime. For example, a developer may use a design time application on the user interface machine 128 to design, create and edit meta-objects 114 for storage on the application server machine 102 in the metadata repository 110. Once the meta-objects have been created and stored in the metadata repository 110, a runtime application on the user interface machine 128 may request the meta-objects from the metadata repository 110 for execution by one or more of the execution engines 108 at runtime.

In one exemplary implementation, the metadata repository 110 stores metadata representations of user interfaces (UIs) that may be sent to one or more user interface front end devices for interpretation and for executing the UIs on the client front end devices. A meta-object 114 is a special kind of business object. The content of a specific meta-object may describe an application instance such as a user interface application. The content of a specific meta-object also may describe, for example, a sales order object instance floor plan, or a concrete business object like a sales order.

Meta-objects 114 may include a meta-object model 120 and an object model 126. In general, an object-model is a collection of concepts that are the vocabulary with which a certain domain can be described. Object-models typically are built according to a strict rule set, which in most cases may be derived from entity-relationship-attribute or object-oriented modeling. In this manner, a front-end application program running on the user interface machine 128 can access and interpret the contents of the metadata repository 110 via the execution engines 108 at runtime.

The meta-object model 120 may include an object model 122 and a debug model 124. The meta-model 120 of a specific domain may be described by an object model 122. In one exemplary implementation, in SAP Business ByDesign, the meta-model of a specific domain is described by a business object model 126. A business object model may be a special object model. Business objects may be an instance of a class or data entity type. Real world objects, for example, an employee or a sales order, may be modeled as business objects. Business objects may be constructed as an entity with multiple layers. At the core of the business object may be the kernel, which represents the object's inherent data. An integrity layer may represent the business logic of the object. It may include the business rules and constraints that apply to the business object. An interface layer may describe the implementation and structure of the business object and define the interface to other applications. An access layer may define the technologies that can be used to obtain external access to the objects data.

The metadata repository 110 also includes where-used meta-objects 116 and an index 118. The where-used meta-object 116 may be used to access the index 118. The metadata repository contains the entire graph of the usage of the complete content of the repository in both directions. One instance of a meta-object (e.g., data type) may be used in other instances of other meta-objects (e.g., business objects) and/or may be indirectly used in other instances of other meta-objects (e.g., user interface). The entire set of this knowledge regarding an instance of a meta-object may be included on the where-used list for this instance (e.g., data type “Amount”). The metadata repository also stores information that an instance of a meta-object (e.g., Create Sales Order User Interface) uses other instances of meta-objects (e.g., Sales Order) which is using other instances of meta-objects (e.g., data type “Amount”). From this direction, the entire set of directly and indirectly used instances leads to the complete bill of material of the Create Sales Order User Interface.

The debug manager 112 may operably coupled to the execution engines 108 and to the metadata repository 110. The debug manager 112 provides an interface to each of the different types of execution engines and is configured to manage one or more debug processes at a metadata level. The debug manager 112 provides the interface which will be used by the different meta-object runtime execution engines 108 to notify the debug manager about special debugging events such as when breakpoints have been reached or when watch point data has changed. In this manner, the debug manager 112 provides a plug and play mechanism for debugging all kinds of meta-objects since the debug manager interface is always the same for all meta-objects stored in the metadata repository 110 and all meta-object runtime execution engines 108. In one exemplary implementation, the debug manager 112 may be implemented as a single instance. This single instance of the debug manager 112 may interface with multiple instances of execution engines 108.

The meta-object models 120 may include a debug model 124. The debug model 124 may be used by the debug manager 112 to get information about supported breakpoints and data watch points of a specific meta-model. Breakpoints may be related to operations and data watch points may be related to structures or tables. The debug model may include the description of the supported operations of a specific meta-model including its supported signature, which may lead to a breakpoint at runtime.

The debug model 124 also may contain information about supported watch points for a specific meta-model. Some of this additional debug information may be related to the meta-model but some of the debug information also may be related to the concrete model instances. For example, a core service operation “retrieve” may be related to a business object meta-model, but the concrete data types of the “retrieve” operation such as the output table, may be related to the concrete business object, for example the sales order business object. At the time of debugging, the debug manager 112 may use the debug model 124 of the specific meta-model and the metadata of the concrete and active model instances.

The debug manager 112 may use the regular metadata application programming interface of the metadata repository to read this kind of metadata for debug purposes. In this manner, no additional metadata repository debug specific interfaces are needed.

The debug manager 112 also provides interfaces for debugger client processes which may be running on a user interface machine such as the user interface machine 128. The user interface machine 128 may include one or more instances of user interface client processes 130, one or more instances of user interface applications 132, a debugger process 134, a debugger service 136, and a processor 142. The user interface machine 128 may be any type of computing device including, for example, a desktop, a laptop, a server, a hand-held device, a smart phone, a tablet, or any other type of computing device. The user interface machine 128 may store instructions on a memory (not shown), which may be executed by the processor 142 to perform one or more actions or functions.

The user interface client processes 130 may include multiple instances of client processes. These client processes include multiple instances of user interface applications 132. These user interface client processes 130 and user interface applications 132 may be used to define meta-objects, for example, business objects, process components and UI text. They also may provide editors such as a UI text editor, a business object editor to create business objects such as, for example, a sales order. The user interface applications 132 may be design time applications, which are used to create and maintain these objects. For each of these contents, there also may be equivalent runtime entities. In one exemplary implementation, the user interface application may be a user interface such as a browser application running in conjunction with a plug-in, such as Microsoft Silver Light.

The debugger process 134 may be a user interface to enable a user to debug applications and meta-objects. The debugger processes may be the user interfaces for a debugger program on the user interface machine 128. The debugger process 134 may include multiple different views to aid a developer in the debugging process. For example, the debugger process 134 may include one or more breakpoint views 138 and one or more data watch views 140. The breakpoint views 138 and the data watch views 140 are the interfaces that enable the developer to set and enable breakpoints and watch points. The views 138 and 140 also provide the interface for the developer to step through a debugging process when a breakpoint or a watch point is reached during runtime.

The debugger service 136 may be an application running on the user interface machine 128. The processor 142 may execute instructions to enable the debugger service 136 to perform its functions. The debugger service 136 provides an interface between the debugger processes 134 on the user interface machine 128 and the debug manager 112 on the application service machine 102. In one exemplary implementation, a single instance of the debugger service 136 is instantiated on the user interface machine 128. The debugger service 136 is configured to manage multiple instances of the debugger process 134 including multiple breakpoint views 138 and multiple data watch views 140. The debug manager 112 is configured to provide an interface to notify the debugger client processes 134, via the debugger service 136, when breakpoints are reached and when data may be changed. The debugger processes 134 can then update the breakpoint views 138 and the data watch views 140. Additionally, the debugger client processes 134 may trigger the debug manager 112 to continue with the execution of the application through the debugger service 136.

In one exemplary implementation, there may be multiple user interface machines. For example, one user interface machine may be configured to communicate over a network with another user interface machine. Both user interface machines may be configured to communicate with the same application server machine 102 over the network. One of the user interface machines may include the user interface applications, which may be running the runtime and/or design time applications. Another user interface machine may be configured to run the debugger service 136 and the debugger processes 134. In this manner, one person may be running a runtime execution of an application on one user interface machine and another person may be running the debugger processes and debugger user interfaces related to the runtime execution of the user interface application on a different user interface machine. The debugger processes 134 provide the interface for the user to set breakpoints and to perform debugging processes when breakpoints are reached. The debug manager 112 notifies the debugger processes when breakpoints are reached. The debugger process 134 may include one or more interfaces to inform the debug manager about debugger related events.

In another exemplary implementation, the debug manager 112 provides another interface to user interface applications 132 running on the user interface machine 128. This interface may include operations to control the debugger. For instance, the user interface application 132 may include an action “debug” which may start the debugger on a stated user interface machine. If the user interface application is not in a request, then the debugger process only starts on the target machine and waits for breakpoints. If the user interface application is processing a request, then the operation breaks the current request and shows the last breakpoint in the already running debugger process.

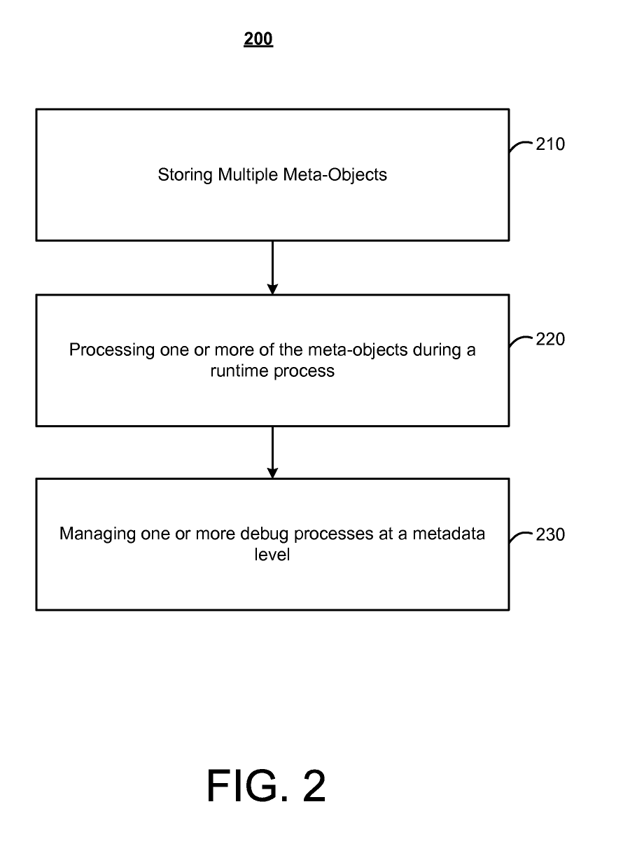

Referring to FIG. 2, an exemplary process 200 is illustrated. Process 200 may include storing multiple meta-objects (210), processing one or more of the meta-objects during a runtime process (220), and managing one or more debug processes at a metadata level (230).

For example, the metadata repository 110 may be configured to store multiple meta-objects 114 (210). The meta-objects may be created on a user interface machine (e.g., user interface machine 128 of FIG. 1) using a user interface application 132 such as a design time application. The created meta-objects may be stored in the metadata repository 110 (210). The design time application may later access and edit the stored meta-objects.

As discussed above, the meta-objects may be processed by one or more runtime execution engines 108 during a runtime process (220). For example, in response to a request by a runtime user interface application, an appropriate execution engine 108 may access or receive the requested meta-object from the metadata repository 110 and process the meta-object for delivery to the runtime user interface application.

The debug manager 112 may configured to manage one or more debug processes at the metadata level (230). For example, the debug manager 112 may provide an interface to the execution engines 108, which may be registered with the debug manager 112. The registration of the execution engines 108 to the debug manager 112 enables the debug manager to monitor and to manage debugging processes when certain debugging events are met. For example, the debug manager 112 may enable and notify the execution engines when breakpoints and/or watch points are reached. The debug manager 112 interfaces with the metadata repository and may use the information in the debug models 124 to manage the debug processes.

The process also may include running at least one debugger client process as a user interface application, interfacing with the debugger client process and notifying the debugger client process of debug information. For example, as discussed above, a debugger process 134 may be run on the user interface machine 128. The debugger process 134 may provide an interface for a user to set, enable, and disable breakpoints and watch points. The debugger process 134 also provides the interface for the user to debug the meta-objects and other applications and programs. The debug manager 112 may interface with the debugger process 134 via the debugger service 136. The debugger service 136 may be configured to manage multiple instances of the debugger process 134 and to route information received from the debug manager 112 to the appropriate debugger process. The debug manager 112 may be configured to notify the debugger process 134, via the debugger service 136, of debug information such as breakpoint related information and watch point related information for a specific meta object.

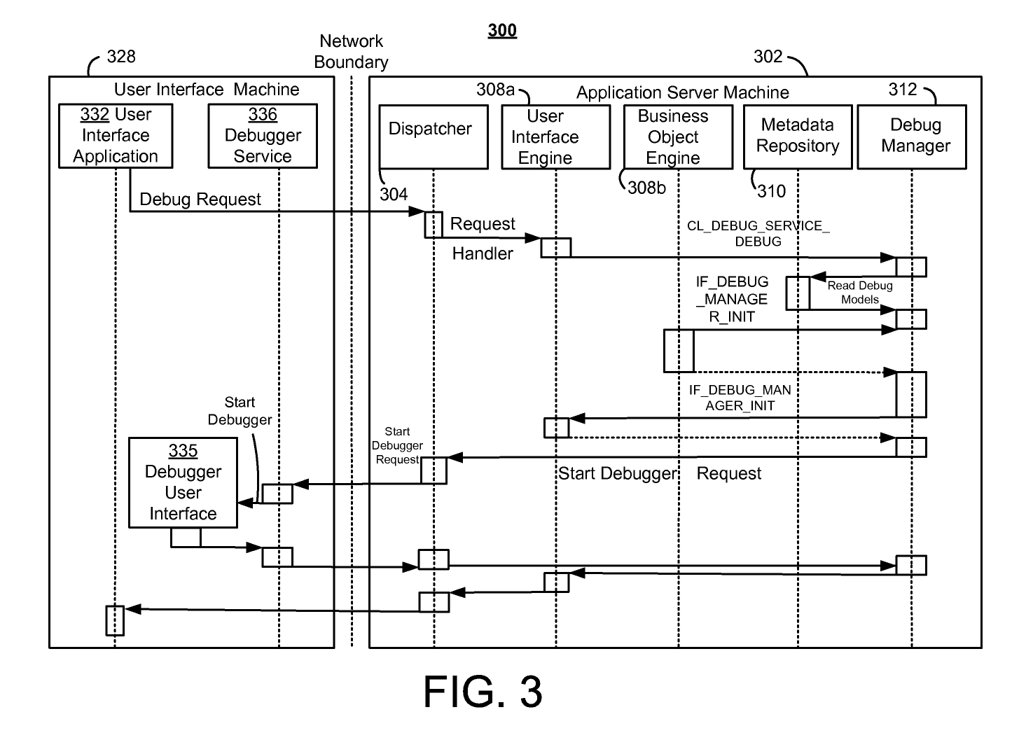

Referring to FIG. 3, a sequence diagram 300 illustrates a sequence to start a debugger on the user interface machine. In FIG. 3, the components described may be the same or similar as those described in the architecture diagram of system 100. For example, the application server 302 and the user interface machine 328 may be the same as the application server machine 102 and the user interface machine 128 of FIG. 1 The user interface application 332, the debugger user interface 335 and the debugger service 336 may be the same as the user interface application 132, the debugger processes 134, and the debugger service 136, respectively of FIG. 1. The dispatcher 304, the user interface engine 308A, the business object engine 308B, the metadata repository 310 and the debug manager 312 may be the same as the corresponding components in FIG. 1. The user interface engine 308A and the business object engine 308B are two implementations of different meta-object runtime execution engines 108, as shown in FIG. 1.

In the user interface application 332, the developer may want to start a debugger process so that the debugger interface will be initiated on the user interface machine 328. The debug request is configured to start the debugger on a standard user interface machine 328. If the user interface application 332 is not in a request, then the debugger process only starts on the target machine and waits for breakpoints. If the user interface application 332 is processing a request, then the operation breaks the current request and shows the actual breakpoint in the already running debugger process.

The user interface application 332 makes a debug request to the application server 302. The user interface application 332 may trigger the debug request for example, via a push button, menu item, or short key in the user interface application. The request is first received by the dispatcher 304 on the application server 302. The dispatcher 304 calls the request handler of the user interface engine 308A. The user interface engine 308A calls the debug service of the debug manager 312.

The interface “CL_DEBUG_SERVICE_DEBUG” is the interface command that starts the debugger on the stated user interface machine. The request may include a string with the name of the user interface machine on which the debugger process is to be started. The request also may include information to indicate whether an additional authentication is needed to ensure that the person who is debugging the user interface application has the correct permissions.

The debug manager 112 is configured to read the debug model (e.g., debug model 124 of FIG. 1) from the metadata repository 310. The debug manager 312 indicates the type of model to be debugged, for example, for a specific type of engine. The debug manager 312 reads the debug models from the metadata repository 310 and calls for each running meta-object execution engine the initialization method.

For example, the interface command “IF_DEBUG_MANAGER_INIT” initializes the meta-object runtime engine for a debugging session and hands over a runtime reference to the debug manager 312. In this example, the debug manager 312 initializes the business object engine 308B and the user interface engine 308A. Each of these engines returns a runtime reference to the debug manager 312. Then, the debug manager 312 sends a “Start Debugger Request” to the debugger service 336 running on the user interface machine 328. The “Start Debugger Request” is initially sent to the dispatcher 304 who forwards the “Start Debugger Request” to the debugger service 336 on the user interface machine 328.

The debugger service 336 starts the debugger user interface process on the debugger user interface 335. In one exemplary implementation, the user interface application and the debug user interface user process may not be running concurrently. In this example, only one process, either the user interface application or the debugger user interface process is enabled for user input. Once the debugger has been started, the developer may perform multiple different debugging processes. The start debugger process sequence is the same for all execution engines. The debug manager 312 calls the debug engine, then calls the user interface. The start debugger is initialized with a request to the UI machine on the debugger service and the debugger service starts the debugger interface on the UI.

In other exemplary implementations, a debugger user interface may be initiated automatically based on one or more runtime evaluation points. For example, one of the execution engines may make a compliance test at runtime and find errors during the compliance test. The finding of errors may trigger the starting of the debugger. In some implementations, the debugger interface may be provided for on the application server machine to enable a developer on the application server to debug a particular engine. For example, there may be a profile parameter that starts the debugger interface.

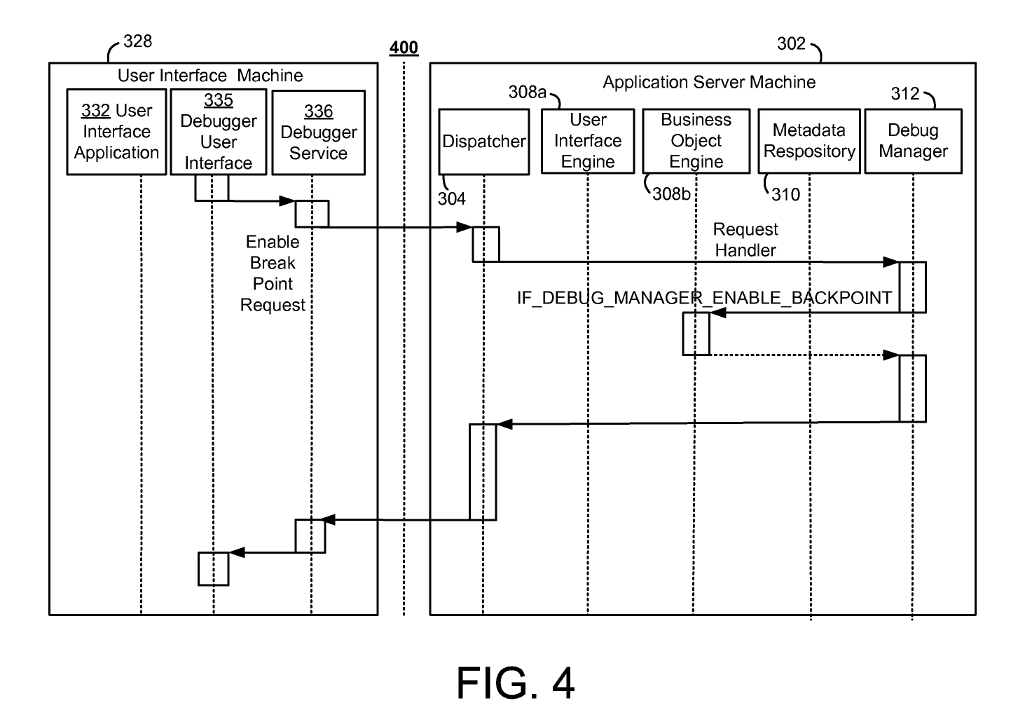

Referring to FIG. 4, a sequence diagram 400 is illustrated. The sequence diagram 400 illustrates a sequence to enable a breakpoint. In FIG. 4, the components described may be the same or similar as those described in the architecture diagram of system 100. For example, the application server 302 and the user interface machine 328 may be the same as the application server machine 102 and the user interface machine 128 of FIG. 1 The user interface application 332, the debugger user interface 335 and the debugger service 336 may be the same as the user interface application 132, the debugger processes 134, and the debugger service 136, respectively of FIG. 1. The dispatcher 304, the user interface engine 308A, the business object engine 308B, the metadata repository 310 and the debug manager 312 may be the same as the corresponding components in FIG. 1. The user interface engine 308A and the business object engine 308B are two implementations of different meta-object runtime execution engines 108, as shown in FIG. 1.

A list of the active meta-object engines and their breakpoints and watch points may be available in the debugger user interface 335 and can be enabled and disabled. For example, the user of the debugger user interface 335 may enable a breakpoint of the business object engine by selecting a type of breakpoint. The enabled breakpoint may be started at the debugger user interface 335. The request is initially sent to the debugger service 336 which forwards the enable breakpoint request to the application server machine 302. The dispatcher 304 on the application server machine 302 receives the request and then makes the call to the debug manager 312. The enable breakpoint request may include the name of the breakpoint as modeled in the debug model (e.g., debug model 124 of FIG. 1). In one exemplary implementation, the user interface may provide a list of names in the form of a string for the developer to select to set a particular breakpoint. The debug manager 312 calls the enable breakpoint method of the business object engine 308B and returns the information back to the debugger user interface 335.

While not specifically illustrated, it is understood that watch points and other debugging processes may be enabled in the same or in a similar manner using the components illustrated in FIG. 4.

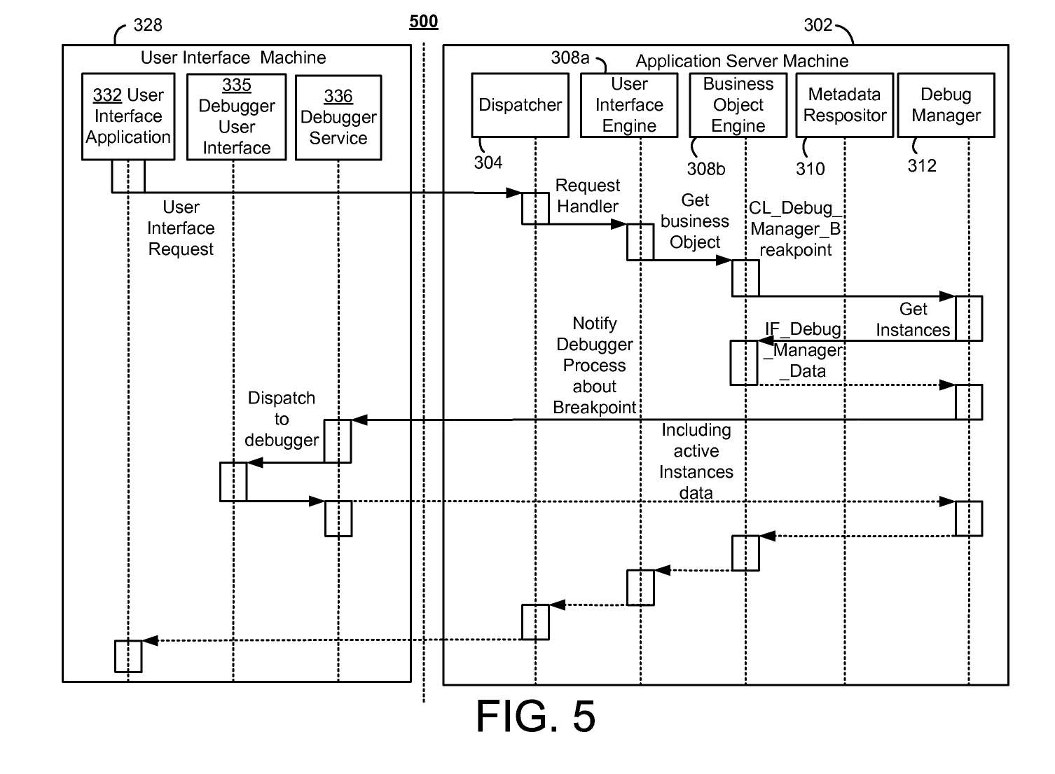

Referring to FIG. 5, a sequence diagram 500 is illustrated. The sequence diagram 500 illustrates a reach breakpoint scenario. In FIG. 5, the components described may be the same or similar as those described in the architecture diagram of system 100. For example, the application server 302 and the user interface machine 328 may be the same as the application server machine 102 and the user interface machine 128 of FIG. 1 The user interface application 332, the debugger user interface 335 and the debugger service 336 may be the same as the user interface application 132, the debugger processes 134, and the debugger service 136, respectively of FIG. 1. The dispatcher 304, the user interface engine 308A, the business object engine 308B, the metadata repository 310 and the debug manager 312 may be the same as the corresponding components in FIG. 1. The user interface engine 308A and the business object engine 308B are two implementations of different meta-object runtime execution engines 108, as shown in FIG. 1.

In this example, the user interface application 332 sends a request to the application server machine 302. The dispatcher 304 sends the request to the proper request handler implemented by the user interface engine. For this example, the dispatcher 304 sends the request handler to the user interface engine 308A. The user interface engine 308A sends the command to get the business object to the business object engine 308B. The business object engine 308B sends the debug manager breakpoint command to the debug manager 312.

The debug manager breakpoint is called by the meta-object runtime execution engine to notify the debug manager 312 that a breakpoint is reached at runtime. The breakpoint is modeled as an additional debug model (e.g., debug model 124 of FIG. 1) in the specific meta-model in the metadata repository 310. The breakpoint can provide additional debug data which may be displayed in the debugger user interface as additional information to the breakpoint. The corresponding user interface, which may be language dependent, includes text to the attributes, which are also part of the debug model. The debug manager 312 retrieves the instances data from the business object engine. The get instances data command includes a table of active instances. The structure of the instance referenced table may be modeled as additional information in the debug model. The information is then sent from the user interface engine 308B to the debug manager 312. The debug manager 312 notifies the debugger process on the user interface machine about the breakpoint including active instances data. The debugger service 336 receives the notification and dispatches the breakpoint information including the active instances data to the appropriate debugger user interface 335.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions stored on a non-transitory computer-readable storage medium, the computer system comprising:
a metadata repository that is arranged and configured to store multiple meta-objects;
at least one execution engine that is operably coupled to the metadata repository and that is arranged and configured to process one or more of the meta-objects during a runtime process; and
a debug manager that is operably coupled to the metadata repository and to the at least one execution engine and that is arranged and configured to provide an interface to the at least one execution engine and to manage one or more debug processes at a metadata level.

2. The computer system of claim 1 wherein:
one or more of the meta-object models comprise an object model and a debug model, wherein the debug model comprises debug information; and
the debug manager is arranged and configured to obtain and use the debug information the manage one or more of the debug processes at the metadata level.

3. The computer system of claim 2 wherein the debug information comprises breakpoint information and watchpoint information for a specific object model.

4. The computer system of claim 1 further comprising:
at least one debugger client process that is arranged and configured to run as a user interface application; and
a debugger service that is arranged and configured to interface between the at least one debugger client process and the debug manager,
wherein the debug manager is arranged and configured to notify the at least one debugger client process of debug information.

5. The computer system of claim 4 wherein the at least one debugger client process comprises a breakpoint view and a datawatch view.

6. The computer system of claim 4 wherein the at least one debugger client process is arranged and configured to enable and disable breakpoints and watchpoints.

7. The computer system of claim 1 further comprising at least one user interface application, wherein the debug manager is arranged and configured to interface with the user interface application to initiate at least one debugger client process.

8. A method including executing instructions recorded on a non-transitory computer-readable storage media using at least one processor, the method comprising:
storing multiple meta-objects;
processing one or more of the meta-objects during a runtime process; and
managing one or more debug processes at a metadata level.

9. The method as in claim 8 wherein one or more of the meta-object models comprise an object model and a debug model, wherein the debug model comprises debug information, and the method further comprising obtaining and using the debug information the manage one or more of the debug processes at the metadata level.

10. The method as in claim 9 wherein the debug information comprises breakpoint information and watchpoint information for a specific object model.

11. The method as in claim 8 further comprising:
running at least one debugger client process as a user interface application;
interfacing with the at least one debugger client process; and
notifying the at least one debugger client process of debug information.

12. The method as in claim 11 wherein the at least one debugger client process comprises a breakpoint view and a datawatch view.

13. The method as in claim 11 further comprising using the at least one debugger client process to enable and disable breakpoints and watchpoints.

14. The method as in claim 8 further comprising interfacing with at least one user interface application to initiate at least one debugger client process.

15. A recordable storage medium having recorded and stored thereon instructions that, when executed, cause at least one processor to perform the actions of:
storing multiple meta-objects;
processing one or more of the meta-objects during a runtime process; and
managing one or more debug processes at a metadata level.

16. The recordable storage medium of claim 15 wherein one or more of the meta-object models comprise an object model and a debug model, wherein the debug model comprises debug information, and further comprising instructions that, when executed, cause the at least one processor to perform the actions of obtaining and using the debug information the manage one or more of the debug processes at the metadata level.

17. The recordable storage medium of claim 16 wherein the debug information comprises breakpoint information and watchpoint information for a specific object model.

18. The recordable storage medium of claim 16 further comprising instructions that, when executed, cause the at least one processor to perform the actions of:
running at least one debugger client process as a user interface application;
interfacing with the at least one debugger client process; and
notifying the at least one debugger client process of debug information.

19. The recordable storage medium of claim 15 wherein the at least one debugger client process comprises a breakpoint view and a datawatch view.

20. The recordable storage medium of claim 15 further comprising instructions that, when executed, cause the at least one processor to perform the action of using the at least one debugger client process to enable and disable breakpoints and watchpoints.
